(19) United States
(12) Patent Application Publication
(10) Pub. No.: US 2012/0207525 A1
(43) Pub. Date: Aug. 16, 2012

(54) RESISTANCE HEATING COMPOSITION AND HEATING COMPOSITE, HEATING APPARATUS, AND FUSING APPARATUS, INCLUDING RESISTANCE HEATING COMPOSITION

(75) Inventors: Dong-ouk KIM, Seoul (KR); Ha-Jin KIM, Hwaseong-si (KR); In-taek HAN, Seoul (KR); Yoon-chul SON, Hwaseong-si (KR); Sang-soo JEE, Hwaseong-si (KR); Dong-earn KIM, Seoul (KR); Sang-eui LEE, Hwaseong-si (KR); Kun-mo CHU, Seongnam-si (KR)

(73) Assignee: SAMSUNG ELECTRONICS CO., LTD., Suwon-si (KR)

(21) Appl. No.: 13/372,140

(22) Filed: Feb. 13, 2012

(30) Foreign Application Priority Data
Feb. 14, 2011 (KR) 10-2011-0013012
Sep. 6, 2011 (KR) 10-2011-0090195

(51) Int. Cl. G03G 15/20; C09K 5/10; H05B 3/10; H05B 3/46; B82Y 30/00

(52) U.S. Cl. 399/335; 219/548; 219/553; 252/74; 252/75; 977/742; 977/750; 977/752

(57) ABSTRACT

A resistance heating composition including carbon nanotubes, an ionic liquid, and a binder resin.

### CROSS-REFERENCE TO RELATED APPLICATIONS

This application claims the benefit of Korean Patent Application No. 10-2011-0013012, filed on Feb. 14, 2011, and Korean Patent Application No. 10-2011-0090195, filed on Sep. 6, 2011, and all the benefits accruing therefrom under 35 U.S.C. §119, the contents of which in their entirety are herein incorporated by reference.

### BACKGROUND

1. Field

The present disclosure relates to resistance heating compositions, and heating composites, heating apparatuses, and fusing apparatuses, which include the resistance heating compositions.

2. Description of the Related Art

With regard to printing apparatuses such as laser printers, copiers, or the like, it is impossible or technically challenging to spray minute powders such as ink. Thus, a printing method of moving toner that is a solid powder, onto a sheet to display an image, includes relatively complex processes such as charging, exposing, developing, transferring, and fusing processes, in order to print and output a desired image on the sheet.

The fusing process of the printing method is a process of fusing toner particles, which are transferred onto the sheet by electrostatic attraction, by applying heat and pressure. Generally, the fusing process is performed by a pair of opposite rollers, that is, a press roller and a heat roller. In this case, power consumption for generating heat occupies most of the total power consumption of the printing process.

A temperature and period of time required to fuse toner particles are determined according to a type of toner. As a surface of a fuser reaches a temperature required to fuse the toner particles more rapidly, a first print out time (“FPPT”) used to perform a first printing process is reduced. With a general printer fuser, because it takes a long time to increase a temperature of the fuser from room temperature to a corresponding fusing temperature so as to perform a printing process, the fuser is preheated at a temperature of about 150° C. to about 180° C., depending on the type of toner. The preheating results in power consumption even during idle time.

Accordingly, there is a need in the art for a fusing system that rapidly increases a temperature of a fuser from room temperature to a fixed temperature, to increase a printing speed, thereby reducing power consumption.

### BRIEF SUMMARY OF THE INVENTION

An embodiment of this disclosure provides a resistance heating composition having high heating uniformity and a high heating rate.

Another embodiment of this disclosure provides a heating composite including the resistance heating composition.

Yet another embodiment of this disclosure provides a heating apparatus including the heating composite.

Still another embodiment of this disclosure provides a fusing apparatus for a printing apparatus, including the heating apparatus.

According to an embodiment, a resistance heating composition includes carbon nanotubes (“CNTs”); an ionic liquid; and a binder resin.

An amount of the CNTs may be about 0.01 to about 300 parts by weight based on 100 parts by weight of the binder resin.

The ionic liquid may include at least one selected from an imidazolium-containing ionic liquid, a thiazolium-containing ionic liquid, and a pyridazinium-containing ionic liquid.

A cation of the ionic liquid may include at least one selected from a cation represented by Formulae 1 through 3 below:

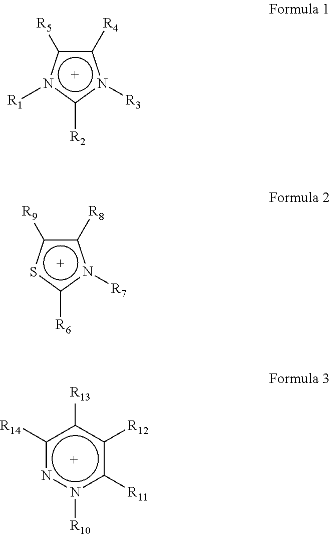

wherein R₁, R₃, R₇, and R₁₀ are each independently a C₁-C₁₀ alkyl group, a phenyl group, or a benzyl group, and R₂, R₄, R₅, R₆, R₈, R₉, and R₁₁ to R₁₄ are each independently a C₁-C₄ alkyl group or hydrogen.

An anion of the ionic liquid may include at least one selected from a chloride ion, a thiocyanate ion, a sulfonate ion, an imide ion, a methide ion, a tetrafluoroborate ion, a hexafluorophosphate ion, a methanesulfonate ion, a trifluoromethanesulfonate ion, and a bis(trifluoromethylsulfonyl)imide ion.

An amount of the ionic liquid may be about 1 to about 1,000 parts by weight based on 100 parts by weight of the CNTs.

The binder resin may include at least one selected from a natural rubber, a silicone, a silicone rubber, a fluorosilicone, a fluoroelastomer, and a synthetic rubber.

According to another embodiment of this disclosure, a heating composite includes a product of the resistance heating composition.

The heating composite may be a surface heater.

According to another embodiment of this disclosure, a heating apparatus includes a base; and the heating composite disposed on the base, wherein the heating composite comprises a product of the resistance heating composition.

A surface of the heating composite may generate direct heat when power is supplied to the heating composite.

The heating apparatus may further include an insulating layer disposed on the heating composite on a side of the heating composite opposite the base.

The heating apparatus may be configured in a roller form or a belt form.

According to another embodiment of this disclosure, a fusing apparatus for a printing apparatus includes the heating apparatus configured in a roller form or a belt form, and includes a base, a heating composite disposed on the base, wherein the heating composite includes a product of a resistance heating composition, and an insulating layer disposed on a surface of the heating composite opposite the base; and a pressing device facing the heating apparatus.

The printing apparatus may be a laser printer.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects, advantages and features of this disclosure will become more apparent by describing in further detail embodiments thereof with reference to the accompanying drawings in which:

FIG. 1 is a diagram showing a concept for dispersing carbon nanotubes (“CNTs”) by using an ionic liquid;

FIG. 2 is a graph of viscosities of resistance heating compositions of Example 1 and Comparative Example 1;

FIG. 3 is a diagram of a heating temperature distribution of a surface of the resistance heating composition of Example 1;

FIG. 4 is a diagram of a heating temperature distribution of a surface of the resistance heating composition of Comparative Example 1;

FIG. 5 is a graph of heating rates of the resistance heating compositions of Example 1 and Comparative Example 1 and shows times taken to reach a predetermined temperature; and

FIG. 6 is a diagram for describing a method of measuring conductivity.

### DETAILED DESCRIPTION

This disclosure will be described more fully hereinafter with reference to the accompanying drawings, in which various embodiments are shown, wherein like reference numerals refer to like elements throughout. This disclosure may, however, be embodied in many different forms, and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting. As used here, the singular forms “a”, “an” and “the” are intended to include the plural forms as well, unless the content clearly indicates otherwise. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning consistent with their meaning in the context of the relevant art and the present disclosure, and will not be interpreted in an idealized or overly formal sense unless expressly so defined herein.

As used herein, the term “alkyl group” refers to a straight or branched chain, saturated, aliphatic hydrocarbon group having the specified number of carbon atoms and having a valence of at least one, optionally substituted with one or more substituents where indicated, provided that the valence of the alky group is not exceeded. An alkyl group includes, for example, a group having from 1 to 50 carbon atoms (C1 to C50 alkyl), specifically 1 to 12 carbon atoms, more specifically 1 to 6 carbon atoms.

As used herein, the term “phenyl group” refers to an unsubstituted, 6-membered aromatic ring, in which all ring members are carbon.

As used herein, the term “benzyl group” refers to a phenyl group attached to a —CH₂— linking group.

According to an embodiment, a resistance heating composition is provided including carbon nanotubes (“CNTs”), an ionic liquid, and a binder resin.

Typically, heat generated from a halogen lamp or the like reaches a surface of a fusing apparatus of a laser printer. In contrast, the resistance heating composition according to an embodiment may constitute a resistance heating layer that directly heats a surface of a heating apparatus, thereby reducing heat loss due to heat transfer, and obtaining a high heating rate.

A CNT included in the resistance heating composition has semiconductor properties and metallic properties according to chirality, and has improved electrical characteristics compared with commonly used silicon-containing electronic devices known in the art. In addition, the CNT is an excellent nano material having high mechanical strength, thermal conductivity, and chemical stability.

The CNT has a heat capacity per unit volume of about 0.9 Joules per Kelvin per cubic centimeter (J/cm³·K) which is much lower than that of other conductive filler materials, for example, stainless steel, which has a heat capacity per unit volume of about 3.6 J/cm³·K. In addition, the CNT has a very high thermal conductivity of about 3,000 Watts per meter Kelvin (W/m·K) or more. Thus, the CNT has an excellent heating efficiency that is improved compared to a typical conductive filter material.

The resistance heating composition includes CNTs that are uniformly dispersed in the binder resin. Carbon nanotubes have at least one minor dimension, for example, width or diameter, of about 100 nanometers (“nm”) or less. The term “nanotubes” refers to elongated structures of like dimensions, for example, nanoshafts, nanopillars, nanowires, nanorods, nanoneedles, and their various functionalized and derivatized fibril forms. The nanotubes may have various cross sectional shapes, such as rectangular, polygonal, oval, elliptical, or circular shape. The CNT may be any CNT that includes at least one selected from a single-walled carbon nanotube, a double-walled carbon nanotube, a multi-walled carbon nanotube, a carbon nanotube bundle, a metallic carbon nanotube, and a semiconducting carbon nanotube, and the like. The different types of carbon nanotubes may used alone or in a combination of one or more different types thereof as a mixture. The carbon nanotubes may have any aspect ratio (width/length) effective for heat transfer as described below, for example from about 5 to about 1,000,000, or from about 50 to about 500,000, or from about 100 to about 100,000. Similarly, the diameter of the carbon nanotubes (including individual carbon nanotubes in a bundle), can be, for example, from 1 to about 80 nm, from about 2 to about 50 nm, or from about 2 to about 10 nm. The

The amount of the CNTs is not particularly limited, and is selected based on the type of CNTs, ionic liquid, and resin binder used, and the desired heat transfer properties as described in more detail below. For example, the amount of the CNTs may be about 0.01 to about 300 parts by weight based on 100 parts by weight of the binder resin so that the CNTs may have improved heating properties and may be uniformly dispersed in the binder resin. For example, the amount of the CNTs may be in various ranges of about 1 to about 200 parts by weight, more specifically about 10 to about 200 parts by weight, still more specifically about 20 to about 200 parts by weight, even more specifically about 20 to about 100 parts by weight, still even more specifically about 30 to about 100 parts by weight, and still even more specifically about 30 to about 75 parts by weight, based on 100 parts by weight of the binder resin.

The ionic liquid included in the resistance heating composition is a salt that is in a melted state in a wide temperature range including room temperature. Without being bound by theory, it is believed that the ionic liquid functions as a dispersant. When CNTs are included in binder resins, the resins may have a high viscosity due to the CNTs included in the binder resin as well as the binder resin itself.

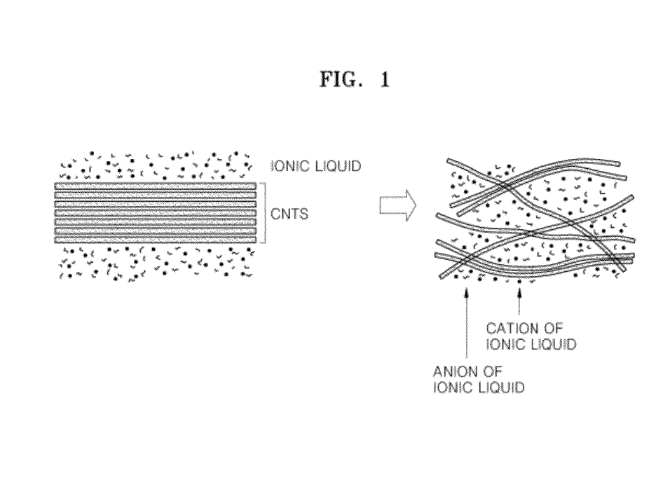

If high electric conductivity of a resistance heating element is desired in order to reduce the power consumption of a printer such as a laser printer, the amount of CNTs included in the heating element is increased, thereby greatly increasing the viscosity of the heating element. Thus, it becomes very difficult, if not impossible, to disperse the CNTs using a physical CNT dispersing method such as a three-roll mill method or an ultrasonic processing method, to process the resistance heating composition used to produce the heating element, and to produce the heating element. However, without being bound by theory, it is believed that inclusion of the ionic liquid in the resistance heating composition as described herein improves the dispersing capacity of the CNTs. Thus, when a high amount of CNTs are included in the resistance heating composition, the ionic liquid may reduce the viscosity of the resistance heating composition and may facilitate the resistance heating composition to have improved or excellent processability. FIG. 1 is a diagram showing a concept for dispersing CNTs using an ionic liquid. Referring to FIG. 1, carbon nanotube bundles are dispersed to have a random or essentially random orientation by the cations and anions of the ionic liquid, thereby reducing the viscosity of the resistance heating composition. Thus, rather than the bundles of CNTs as shown in FIG. 1, the CNTs are more separated from each other and dispersed throughout the liquid. This method may be particularly useful where high aspect ratio CNTs are used (for example, nanotubes having an aspect ratio of at least about 1,000, at least about 5,000, or at least about 10,000, and as high as about 500,000) because such CNTs are particularly likely to form aggregations or bundles.

The ionic liquid is selected based on its compatibility with the binder resin and the products formed from the resistance heating compositions when in use, for example in printing, and may be any commonly used ionic liquid as long as the ionic liquid may increase the dispersing capacity with respect to CNTs. In this case, the compatible ionic liquids do not significantly delay or stop any cure reaction of the binder, and phase separation does not occur. It is also preferable for the ionic liquid to not significantly degrade the binder resin during storage or use, or significantly adversely affect the use of the product, for example printing.

According to an embodiment of this disclosure, the ionic liquid may include at least one selected from an imidazolium-containing ionic liquid, a thiazolium-containing ionic liquid, and a pyridazinium-containing ionic liquid. Thus, a combination of different ionic liquids can be used.

An imidazolium-containing ionic liquid may include 1-ethyl-3-methylimidazolium bis(trifluoromethylsulfonyl)imide, 1-butyl-3-methylimidazolium bis(trifluoromethylsulfonyl)imide, 1-butyl-3-methylimidazolium hexafluorophosphate, 1-hexyl-3-methylimidazolium hexafluorophosphate, 1-octyl-3-methylimidazolium hexafluorophosphate, 1-decyl-3-methylimidazolium hexafluorophosphate, 1-benzyl-3-methylimidazolium hexafluorophosphate, 1-butyl-3-methylimidazolium tetrafluoroborate, 1-ethyl-3-methyl-imidazolium tetrafluoroborate, 1-benzyl-3-methylimidazolium tetrafluoroborate, 1-methyl-3-ethylimidazolium chloride, 1-ethyl-3-butylimidazolium chloride, 1-methyl-3-butylimidazolium chloride, 1-methyl-3-propylimidazolium chloride, 1-methyl-3-hexylimidazolium chloride, 1-methyl-3-hexylimidazolium chloride, 1-methyl-3-octylimidazolium chloride, 1-methyl-3-decylimidazolium chloride, 1-benzyl-3-methylimidazolium chloride, 1-ethyl-3-methylimidazolium chloride, or 1-hexyl-3-methylimidazolium chloride.

A thiazolium-containing ionic liquid may include 3-butyl-4-methylthiazolium tetrafluoroborate, or 3-butyl-5-methylthiazolium tetrafluoroborate.

A pyridazinium-containing ionic liquid may include 1-SF₅(CF₂)₂(CH₂)₂-pyridazinium bis((trifluoromethyl)sulfonyl)imide, 1-SF₅(CF₂)₂(CH₂)₄-pyridazinium bis((trifluoromethyl)sulfonyl)imide, 1-butylpyridazinium hexafluorophosphate, or 1-butylpyridazinium tetrafluoroborate.

According to an embodiment, a cation of the ionic liquid may include at least one selected from a cation represented by Formulae 1 through 3 below.

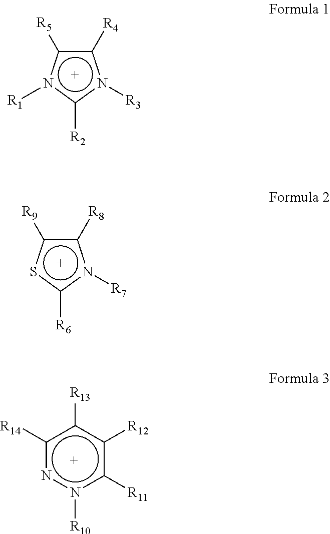

In Formulae 1 through 3, R₁, R₃, R₇, and R₁₀ are each independently a C₁-C₁₀ alkyl group, a phenyl group, or a benzyl group, and R₂, R₄, R₅, R₆, R₈, R₉, and R₁₁ to R₁₄ are each independently a C₁-C₄ alkyl group or hydrogen.

More specifically, in Formulae 1 through 3, R₁, R₃, R₇, and R₁₀ are each independently a C₁-C₆ alkyl group or a benzyl group, and R₂, R₄, R₅, R₆, R₈, R₉, and R₁₁ to R₁₄ are each independently hydrogen.

In addition, an anion of the ionic liquid may include at least one selected from a chloride ion, a thiocyanate ion, a sulfonate ion, an imide ion, a methide ion, a tetrafluoroborate ion, a hexafluorophosphate ion, a methanesulfonate ion, a trifluoromethanesulfonate ion, and a bis(trifluoromethylsulfonyl)imide ion.

A dispersion degree of the ionic liquid of the resistance heating composition by which the CNTs are dispersed, may be checked by measuring a heating temperature distribution of a heating composite comprising the resistance heating composition. As described later, a resistance heating composition comprising an ionic liquid has a characteristic in that heat is uniformly generated by uniform dispersion of CNTs compared with a resistance heating composition that does not include an ionic liquid.

The amount of the ionic liquid in the resistance heating composition may be determined according to the type of the CNTs, the binder resin, and the ionic liquid. In an embodiment, the amount of the ionic liquid may be in the range of about 1 to about 1,000 parts by weight based on 100 parts by weight of the CNTs, and is selected in consideration of a dispersion degree with respect to the CNTs and the processability of the resistance heating composition. For example, the amount of the ionic liquid may be about 10 to about 300 parts by weight based on 100 parts by weight of the CNTs, and more specifically, may be about 50 to about 200 parts by weight based on 100 parts by weight of the CNTs.

The binder resin included in the resistance heating composition may be any binder resin provided that the binder resin constitutes a matrix base in which the CNTs are dispersed, is suitable for use in the intended application, and is compatible with the ionic liquid.

For example, thermoplastic resins may be used as the binder resins, provided that the thermoplastic resins have a glass transition temperature (“Tg”) above the operating temperatures in the intended application, for example a Tg of greater than about 250° C. Examples of the binder resins of this type may include certain polyimides, polyesters, polyetheretherketones (“PEEK”), poly(arylene oxide)s, and polyamides, which may be used alone or in a combination of one or more thereof. Thermosetting (i.e., curable or crosslinkable) resins are more commonly used. Examples of the binder resin may include natural rubber, synthetic rubber such as ethylene propylene diene monomer (“EPDM”) rubber, styrene butadiene rubber (“SBR”), butadiene rubber (“BR”), nitrile butadiene rubber (“NBR”), isoprene rubber, and polyisobutylene rubber, silicones and silicone rubbers such as polydimethyl siloxane and fluorosilicones, and fluoroelastomers such as tetrafluoroethylene, perfluoro(methyl vinyl ether), perfluoro(propyl vinyl ether), perfluoro(ethyl vinyl ether), vinylidene fluoride, and hexafluoropropylene. The binder resins may be used alone or in a combination of one or more thereof. According to an embodiment of this disclosure, a two-component curable silicone rubber may be used as the binder resin in order to ensure thermal resistance at high temperature and desired mechanical characteristics.

In addition, the resistance heating composition may further include an inorganic filter in order to improve thermal resistance. Examples of the inorganic filter may include metal carbonates, metal sulfates, metal oxides and hydroxides, ceramics, non-metal oxides, and metals, such as calcium carbonate, magnesium carbonate, calcium sulfate, magnesium sulfate, iron oxide, zinc oxide, magnesium oxide, aluminum oxide, calcium oxide, titanium oxide, calcium hydroxide, magnesium hydroxide, aluminum hydroxide, microcrystal silica, fumed silica, boron nitride, silicon carbides, nickel, copper, silver, gold, iron, natural zeolite, synthetic zeolite, bentonite, activated clay, talc, kaolin, mica, diatomaceous earth, and clay, which may be used alone or in a combination of one or more thereof.

The resistance heating composition may further include an appropriate additive, for example, an oxidation-resistance stabilizer, a weather-resistance stabilizer, an antistatic agent, dye, pigment, a dispersant, and a coupling agent, if necessary, as long as the heating efficiency of the resistance heating composition is not significantly adversely affected.

The heating composition may be produced by combination of the components thereof as described above. In an embodiment, the CNTs may be pre-mixed with all or a portion of the ionic liquid before incorporation into the binder resin. Mechanical or other means (e.g., ultrasound) may be used to combine the CNTs and the ionic liquid. Still further, the CNTs may be pre-mixed with the ionic liquid, then combined with the solvent, and then combined with the binder resin. Other orders of addition may be used.

Since the resistance heating composition may uniformly disperse a high amount of CNTs in a matrix base in a high viscosity environment and may reduce the viscosity during a processing process while having improved or excellent mechanical characteristics, such as thermal resistance or the like, the resistance heating composition may be used to prepare a heating composite having improved or excellent quality, for example, high heating efficiency and low temperature variation.

A heating composite according to an embodiment of this disclosure includes a product of the resistance heating composition. The heating composite is a CNT composite in which CNTs are uniformly dispersed in the matrix base obtained by curing or cooling the binder resin. The heating composite may be manufactured, for example, as follows.

The resistance heating composition may be prepared as a mixture in a gel state by using a solvent such as methyl isobutyl ketone, propylene glycol methyl ether acetate (“PGMEA”), ethyl acetate, isopropyl acetate, butyl acetate, acetone, or methyl ethyl ketone, in order to uniformly mix the CNTs, the ionic liquid, and the binder resin, and may further include a curing agent or crosslinking agent in order to cure the mixture. Curing or crosslinking agents for specific binder resins are known in the art, and are present in amounts effective for cure of the binder resin. For example, the curing agent may be a platinum-containing catalyst or a palladium-containing catalyst when the binder resin is a curable silicone, or a peroxide when the binder resin is a fluoroelastomer.

The heating composite may be prepared as a film-type surface heater by coating the resistance heating composition to a predetermined thickness by sequentially performing one or more of known methods such as spin coating, dip coating, spray coating, roll coating, bar coating, brush coating, pad application, casting, extruding, projecting, injection molding (a press method), and calendaring, and then curing or cooling the resistance heating composition. The curing process may be determined by the binder resin and the curing agent used, and may include, for example, a step-wise curing process. Curing schedules known to those skilled in the art are within the scope of embodiments herein. If a solvent is used, the solvent can be removed by evaporation or heating before or during curing, or before cooling.

A heating apparatus according to an embodiment of this disclosure includes a base having a surface; and the above-described heating composite disposed on the surface of the base. The heating apparatus may further include an insulating layer disposed on a side of the heating composite opposite the base, for insulation. Other layers may be present, for example a resilient layer on between the heating composite and the insulating layer, or disposed on the insulating layer on a side opposite the heating composite. The heating apparatus may be configured in any form, for example as a belt, a plate, a sheet, a roll, or the like. In an embodiment the heating apparatus is configured in a roller form or a belt form according to a structure of a fusing system of a printing apparatus such as a laser printer, a copier, or the like.

When power is supplied to the heating composite disposed on the base of the heating apparatus, heat is generated directly from a surface of the heating apparatus by Joule heat due to a current, and a fast heating. In contrast, using a known method, heat is generated from a halogen lamp or the like, and is indirectly transferred, resulting in heat loss due to heat transfer. Accordingly, in an embodiment a fusing system that has an increased printing speed and does not have to be preheated may be obtained, and thus power consumption of the printing apparatus may be remarkably reduced.

A fusing apparatus for a printing apparatus, according to an embodiment of this disclosure includes the above-described heating apparatus and a pressing device facing the heating apparatus. According to an embodiment, the heating apparatus may be a configured as a heat roller and the pressing device may be a press roller. The fusing apparatus may be used in a printing apparatus such as a laser printer, a copier, or the like.

Hereinafter, one or more embodiments will be described in detail with reference to the following examples and comparative examples. However, the following examples and comparative examples are for illustrative purposes only and are not intended to limit the purpose and scope of one or more embodiments.

In the Examples, the amounts of CNTs are based on 100 parts by weight of a two-component curable silicone rubber.

### Example 1

1 gram (g) of multi-walled carbon nanotubes (“MWCNTs”), and 2 g of 1-ethyl-3-methylimidazolium bis(trifluoromethylsulfonyl)imide (“EMIMTFSI”) as an ionic liquid, were put in a mortar and were stirred using a pestle for one hour at a predetermined speed to prepare a mixture in which the ionic liquid was mixed between CNTs. 60 milliliters (ml) of methyl iso-butyl ketone solvent was added to the mixture and the mixture was mixed using a mortar stick for 30 minutes. 9.54 g of a two-component curable silicone rubber as a binder resin was added to the resulting mixture and was carefully and uniformly mixed using a pestle for 10 minutes. 300 ml of methyl iso-butyl ketone was further added to the resulting mixture. The mixture was transferred to a beaker, the mixture was stirred using a magnetic stirrer for three hours at a high speed, and then the mixture was processed using an ultrasonicator for 3 minutes to prepare a mixture in a gel state, in which the CNTs, the ionic liquid, and the two-component curable silicone rubber were uniformly mixed in the methyl iso-butyl ketone solvent. A predetermined amount of the solvent was removed by heating the resulting mixture. Then, 0.954 g of a curing agent including a platinum (Pt) compound as an effective catalyst was put in the resulting mixture and was uniformly mixed using a magnetic stirrer to provide a resistance heating composition (paste) including 9.5 parts by weight of CNTs. The resistance heating composition was uniformly coated on a substrate (a heat resistant polymer film having a cylindrical tube shape), primarily cured at 150° C. for 30 minutes and then secondarily cured at 200° C. for 4 hours to prepare a surface heating composite disposed on the polymer film.

### Example 2

A heating composite was prepared in the same manner as in Example 1 except that 13 parts by weight of CNTs were used by using 0.5 g of MWCNTs and 0.5 g of EMIMTFSI as an ionic liquid and adjusting amounts of a binder resin and a curing agent.

### Example 3

A heating composite was prepared in the same manner as in Example 1 except that 33 parts by weight of CNTs were used by using 0.5 g of MWCNTs and 0.5 g of EMIMTFSI as an ionic liquid and by adjusting amounts of a binder resin and a curing agent.

### Example 4

A heating composite was prepared in the same manner as in Example 1 except that 50 parts by weight of CNTs were used by using 0.5 g of MWCNTs and 0.5 g of EMIMTFSI as an ionic liquid and by adjusting amounts of a binder resin and a curing agent.

### Example 5

A heating composite was prepared in the same manner as in Example 1 except that 75 parts by weight of CNTs were used by using 0.5 g of MWCNTs and 0.5 g of EMIMTFSI as an ionic liquid and by adjusting amounts of a binder resin and a curing agent.

### Example 6

A heating composite was prepared in the same manner as in Example 1 except that 33 parts by weight of CNTs were used by using 0.5 g of MWCNTs and 0.5 g of 1-butyl-3-methylimidazolium bis(trifluoromethylsulfonyl)imide (“BMIMTFSI”) instead of EMIMTFSI as an ionic liquid and by adjusting amounts of a binder resin and a curing agent.

### Example 7

A heating composite was prepared in the same manner as in Example 6 except that 75 parts by weight of CNTs were used by adjusting amounts of a binder resin and a curing agent.

### Comparative Examples 1 to 7

In Comparative Examples 1 to 7, heating composites were prepared in the same manner as in Examples 1 to 7, respectively, except that an ionic liquid was not used and amounts of a binder resin and a curing agent were adjusted in order to obtain the amounts of CNTs used in Examples 1 to 7, respectively.

### Evaluation Example 1

### Measurement of Viscosity of Resistance Heating Composition

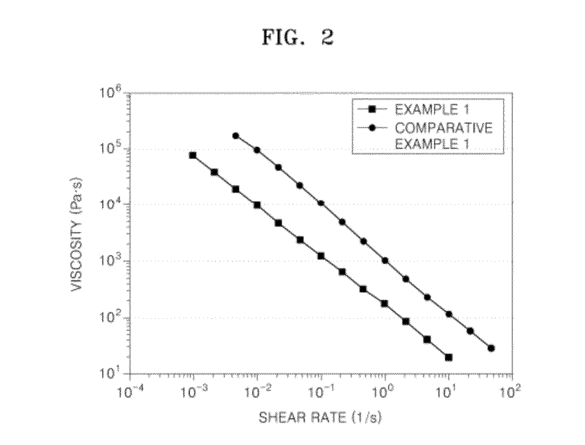

Viscosities of the resistance heating compositions of Example 1 and Comparative Example 1 were measured and the results are shown in FIG. 2. In order to measure the viscosities, an amount of a methyl isobutyl ketone (“MIBK”) was adjusted so as to have a mass ratio of about 15:85 with respect to a heating composition before a curing agent was added to a binder resin that is a mixture of three components, namely, CNTs, an ionic liquid, and a binder resin. Then, predetermined distances between circular turn tables of viscosity measuring equipment (Equipment Name: Viscometer or Rheometer, Model Name: AR series, and Manufacturer: TA INSTRUMENTS) were set and then the resistance heating compositions having volumes corresponding to spaces between the circular turn tables were put in the spaces. When the circular turn tables were rotated at a shear rate that was set from 10⁻³ to 10³ in units of 1/second, forces were generated. Dynamic viscosity values were measured in units of pascal-second by measuring the generated forces.

Referring to FIG. 2, although the resistance heating composition of Example 1 includes a high amount of CNTs, the viscosity of the resistance heating composition is remarkably reduced compared to Comparative Example 1. Thus, the CNTs are uniformly dispersed so as to obtain excellent processability.

### Evaluation Example 2

### Measurement of Heating Efficiency

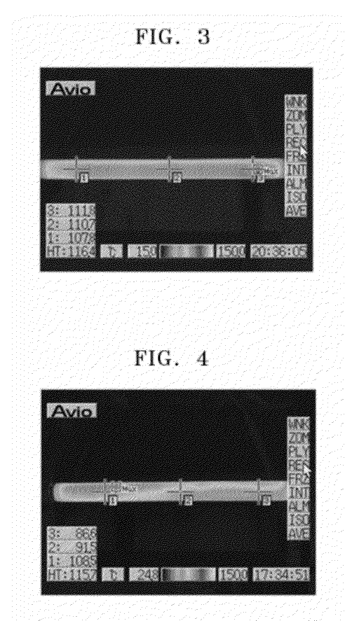

In order to measure the heating efficiencies of the heating composite of Example 1 using the ionic liquid, and the heating composite of Comparative Example 1 that does not use the ionic liquid, heating temperature distributions of surfaces of the cylindrical heating composites were observed by an infrared camera (TVS-500EX series, and available from NEC Avio Infrared Technologies). The result related to Example 1 is shown in FIG. 3 and the result related to Comparative Example 1 is shown in FIG. 4.

Referring to FIGS. 3 and 4, the heating composite of Comparative Example 1 that does not use the ionic liquid has a non-uniform temperature distribution. In contrast, the CNTs of the heating efficiencies of the heating composite of Example 1 using the ionic liquid are uniformly dispersed, and thus heat is uniformly generated without positional deviation.

### Evaluation Example 3

### Measurement of Heating Rate

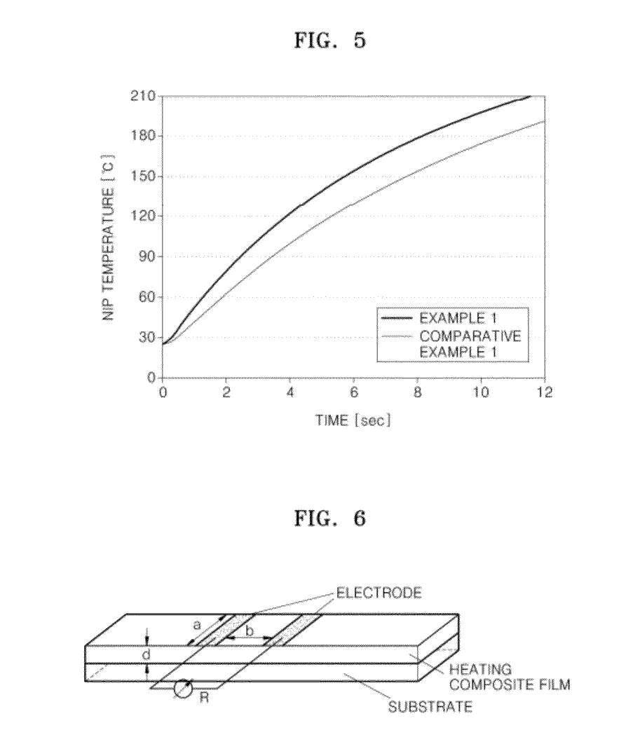

With regard to the heating composites of Example 1 and Comparative Example 1, the times taken to reach a predetermined temperature were measured. The results are shown in FIG. 5, plotting NIP temperature in ° C. as a function of time in seconds.

Referring to FIG. 5, the heating composite of Example 1 using the ionic liquid reaches a predetermined temperature within a shorter period of time than that of the heating composite of Comparative Example 1 that does not use the ionic liquid. Accordingly, the heating composite of Example 1 using the ionic liquid has a higher heating efficiency and thus a higher heating rate than the heating composite of Comparative Example 1.

### Evaluation Example 4

### Measurement of Conductivity of Heating Composite

In order to measure the heating composites of Examples 1 to 7 and Comparative Examples 1 to 7, the heating composites of Examples 1 to 7 and Comparative Examples 1 to 7 were formed in rectangular film forms on a substrate, conductive silver pastes were linearly coated in parallel to each other on two ends of the film and were dried, and then were cured in an oven at 100° C. Conductivity in Siemens per meter (“S/m”) was calculated by using resistivity and the size of the heating composite film according to Equations below, and further described in FIG. 6. The measurement of conductivity is based on the international standard ‘IEC Standard 93 (VDE 0303, Part 30)’ or ‘ASTM D 257’.

Resistivity: ρ=R·d·a/b [Ωm]

Sheet resistance (a=b): R_{sq} [Ω_{sq}]

=>ρ=R_{sq}·d [Ωm]

Conductivity: σ=1/ρ [S/m]
a: length of electrode [m] (wherein m is meters)
b: distance between electrodes [m]
d: thickness of film [m], d>>a, b
R: resistance [Ohm]

The conductivities of the heating composites of Examples 1 to 7 and Comparative Examples 1 to 7 are shown in Table 1 below.

TABLE 1

| | Ratio of | | |
|---|---|---|---|
| | MWCNT | | |
| | (Part | Type of Ionic | Conductivity |
| | by weight) | Liquid | (S/m) |
| Example 1 | 9.5 | EMIMTFSI | 171.26 |
| Example 2 | 13 | EMIMTFSI | 204.85 |
| Example 3 | 33 | EMIMTFSI | 814.07 |
| Example 4 | 50 | EMIMTFSI | 864.75 |
| Example 5 | 75 | EMIMTFSI | 2258.04 |
| Example 6 | 33 | BMIMTFSI | 712.38 |
| Example 7 | 75 | BMIMTFSI | 855.78 |
| Comparative | 9.5 | Non use | 119.2 |
| Example 1 | | | |
| Comparative | 13 | Non use | 137.1 |
| Example 2 | | | |
| Comparative | 33 | Non use | (Impossible to measure |
| Example 3 | | | conductivity due to lack of |
| | | | processability) |
| Comparative | 50 | Non use | (Impossible to measure |
| Example 4 | | | conductivity due to lack of |
| | | | processability) |
| Comparative | 75 | Non use | (Impossible to measure |
| Example 5 | | | conductivity due to lack of |
| | | | processability) |
| Comparative | 33 | Non use | (Impossible to measure |
| Example 6 | | | conductivity due to lack of |
| | | | processability) |
| Comparative | 75 | Non use | (Impossible to measure |
| Example 7 | | | conductivity due to lack of |
| | | | processability) |

As shown in Table 1, with regard to the heating composite including the ionic liquid, as the amount of CNTs is increased, conductivity also increases.

With regard to the heating composite including the ionic liquid, CNTs are uniformly dispersed and thus heat is uniformly generated, compared with the heating composite that does not use the ionic liquid (refer to Evaluation Example 2). A heating temperature of the heating composite including the ionic liquid is also higher than that of the heating composite that does not use the ionic liquid (refer to Evaluation Example 3). Thus, heating efficiencies are not largely affected by a slight difference in conductivity.

In addition, the heating composite including the ionic liquid has excellent processability. In particular, as the amount of CNTs is increased, the processability is remarkably improved. For example, when an amount of CNTs is high, that is, 30 parts by weight or more based on 100 parts by weight of the binder resin, it is impossible to measure conductivity of the heating composite that does not include the ionic liquid since the heating composite is incapable of being processed. In contrast, the heating composite including the ionic liquid has high conductivity since the heating composite is capable of being stably processed.

As described above, according to the embodiments of this disclosure, the resistance heating composition may constitute a heating composite having excellent quality, for example, having high heating efficiency and low temperature variation. When the heating composition is used in a fusing apparatus of a laser printer or the like, a printing speed may be increased and power consumption may be remarkably reduced due to a high heating rate.

While this disclosure has been described in connection with what is presently considered to be practical exemplary embodiments, it is to be understood that the invention is not limited to the disclosed embodiments, but, on the contrary, is intended to cover various modifications and equivalent arrangements included within the sprit and scope of the appended claims . . . . Descriptions of features or aspects within each embodiment should typically be considered as available for other similar features or aspects in other embodiments.

What is claimed is:

1. A resistance heating composition comprising:
carbon nanotubes;
an ionic liquid; and
a binder resin.

2. The resistance heating composition of claim 1, wherein the carbon nanotubes comprises at least one selected from a single-walled carbon nanotube, a double-walled carbon nanotube, a multi-walled carbon nanotube, a carbon nanotube bundle, a metallic carbon nanotube, and a semiconducting carbon nanotube.

3. The resistance heating composition of claim 1, wherein an amount of the carbon nanotubes is about 0.01 to about 300 parts by weight based on 100 parts by weight of the binder resin.

4. The resistance heating composition of claim 1, wherein the carbon nanotubes are uniformly dispersed in the binder resin.

5. The resistance heating composition of claim 1, wherein the ionic liquid comprises at least one selected from an imidazolium-containing ionic liquid, a thiazolium-containing ionic liquid, and a pyridazinium-containing ionic liquid.

6. The resistance heating composition of claim 1, wherein a cation of the ionic liquid comprises at least one selected from a cation represented by Formulae 1 through 3 below: 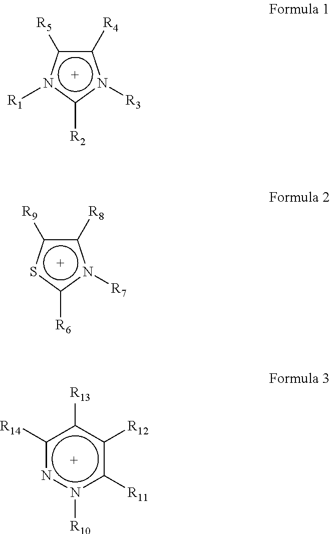
wherein R₁, R₃, R₇, and R₁₀ are each independently a C₁-C₁₀ alkyl group, a phenyl group, or a benzyl group, and R₂, R₄, R₅, R₆, R₈, R₉, and R₁₁ to R₁₄ are each independently a C₁-C₄ alkyl group or hydrogen.

7. The resistance heating composition of claim 5, wherein the imidazolium-containing ionic liquid is selected from 1-ethyl-3-methylimidazolium bis(trifluoromethylsulfonyl)imide, 1-butyl-3-methylimidazolium bis(trifluoromethylsulfonyl)imide, 1-butyl-3-methylimidazolium hexafluorophosphate, 1-hexyl-3-methylimidazolium hexafluorophosphate, 1-octyl-3-methylimidazolium hexafluorophosphate, 1-decyl-3-methylimidazolium hexafluorophosphate, 1-benzyl-3-methylimidazolium hexafluorophosphate, 1-butyl-3-methylimidazolium tetrafluoroborate, 1-ethyl-3-methyl-imidazolium tetrafluoroborate, 1-benzyl-3-methylimidazolium tetrafluoroborate, 1-methyl-3-ethylimidazolium chloride, 1-ethyl-3-butylimidazolium chloride, 1-methyl-3-butylimidazolium chloride, 1-methyl-3-propylimidazolium chloride, 1-methyl-3-hexylimidazolium chloride, 1-methyl-3-hexylimidazolium chloride, 1-methyl-3-octylimidazolium chloride, 1-methyl-3-decylimidazolium chloride, 1-benzyl-3-methylimidazolium chloride, 1-ethyl-3-methylimidazolium chloride, and 1-hexyl-3-methylimidazolium chloride.

8. The resistance heating composition of claim 1, wherein an anion of the ionic liquid comprises at least one selected from a chloride ion, a thiocyanate ion, a sulfonate ion, an imide ion, a methide ion, a tetrafluoroborate ion, a hexafluorophosphate ion, a methanesulfonate ion, a trifluoromethanesulfonate ion, and a bis(trifluoromethylsulfonyl)imide ion.

9. The resistance heating composition of claim 1, wherein an amount of the ionic liquid is about 1 to about 1,000 parts by weight based on 100 parts by weight of the carbon nanotubes.

10. The resistance heating composition of claim 1, wherein the binder resin comprises at least one selected from a natural rubber, a silicone, a silicone rubber, a fluorosilicone, a fluoroelastomer, and a synthetic rubber.

11. A heating composite comprising a product of a resistance heating composition, wherein the resistance heating composition comprises
carbon nanotubes,
an ionic liquid, and
a binder resin.

12. The heating composite of claim 11, wherein the heating composite is a surface heater.

13. The heating composite of claim 11, wherein the product is a cured product of the resistance heating composition.

14. A heating apparatus comprising:
a base; and
a heating composite disposed on the base, wherein the heating composite comprises a product of a resistance heating composition comprising,
carbon nanotubes,
an ionic liquid, and
a binder resin.

15. The heating apparatus of claim 14, wherein a surface of the heating composite generates heat when power is supplied to the heating composite.

16. The heating apparatus of claim 14, further comprising an insulating layer disposed the heating composite on a side of the heating composite opposite the base.

17. The heating apparatus of claim 14, wherein the heating apparatus is configured in a roller form or a belt form.

18. A fusing apparatus for a printing apparatus, the fusing apparatus comprising:
a heating apparatus configured in a roller form or a belt form, and comprising
a base,
a heating composite disposed on the base, wherein the heating composite comprises a product of a resistance heating composition comprising carbon nanotubes, an ionic liquid, and a binder resin, and
an insulating layer disposed on a surface of the heating composite opposite the base; and
a pressing device facing the heating apparatus.

18. The fusing apparatus of claim 18, wherein the printing apparatus is a laser printer.
